(19) United States
(12) Patent Application Publication
(10) Pub. No.: US 2011/0022954 A1
(43) Pub. Date: Jan. 27, 2011

(54) IMAGE PROCESSING APPARATUS AND CONTROL METHOD THEREOF

(75) Inventor: Yuka Kamiya, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/831,545

(22) Filed: Jul. 7, 2010

(30) Foreign Application Priority Data
Jul. 27, 2009 (JP) 2009-174731

(51) Int. Cl. G06F 3/14

(52) U.S. Cl. 715/274

(57) ABSTRACT

This invention provides an image processing apparatus that allows the user to verify the execution result of a created cooperation processing flow, and a control method thereof. To accomplish this, based on registration type information of a cooperation processing flow (script) required to execute a plurality of functions in cooperation with each other, when the cooperation processing flow is in a registered state, an image processing apparatus of this invention executes processing according to the definition of the cooperation processing flow. On the other hand, when the cooperation processing flow is in a provisionally-registered state, the apparatus changes at least one function included in the cooperation processing flow so as to allow the user who executes the cooperation processing flow to verify its execution result, and executes the changed cooperation processing flow.

### BACKGROUND OF THE INVENTION

1. Field of the Invention

The present invention relates to an image processing apparatus such as a multifunction peripheral and a control method thereof.

2. Description of the Related Art

An image processing apparatus such as a multifunction peripheral (MFP), which stores a cooperation processing flow (to be referred to as “script” hereinafter) that defines the sequence of cooperation processing to execute a plurality of functions that cooperate with each other, and that implement the cooperation processing based on the script, is known. For example, Japanese Patent Laid-Open No. 2007-310468 has proposed a program which automates transitions among a plurality of windows and execution of a plurality of processes by pre-storing a designated window order and intra-window setting values as a user defined flow in an image forming apparatus.

However, the aforementioned related art cannot be sufficiently provide a mechanism that verifies whether or not, for example, the execution result of a created script is proper. For example, when an MFP executes a script for sending a scanned image to an external apparatus or file system according to a user instruction, the apparatus that executes the script is different from a destination apparatus of the image. In this case, the user who executed the script cannot confirm the image as the execution result on site, and cannot verify the propriety of the execution result of the created script.

### SUMMARY OF THE INVENTION

The present invention has been made in consideration of the aforementioned problems, and provides an image processing apparatus that allows the user to verify the execution result of a created script, and a control method thereof.

One aspect of the present invention provides an image processing apparatus, which executes cooperation processing according to a cooperation processing flow which defines, in advance, a sequence of the cooperation processing for executing a plurality of functions in cooperation with each other, the apparatus comprising: a storage unit that stores the cooperation processing flow together with registration type information indicating one of a registered state in which verification of an execution result is complete and a provisionally-registered state before completion of verification of the execution result; a change unit that changes, when the cooperation processing flow corresponding to an execution request is in the provisionally-registered state, at least one function included in the cooperation processing flow to a function that allows a user to verify an execution result of the cooperation processing flow; and an execution unit that executes, when the cooperation processing flow corresponding to an execution request is in the registered state, processing according to the cooperation processing flow, and executes, when the cooperation processing flow is in the provisionally-registered state, the processing according to the cooperation processing flow changed by the change unit.

Another aspect of the present invention provides an image processing apparatus, which executes cooperation processing according to a cooperation processing flow which defines, in advance, a sequence of the cooperation processing for executing a plurality of functions in cooperation with each other, the apparatus comprising: a storage unit that stores the cooperation processing flow together with registration type information indicating one of a registered state in which verification of an execution result is complete and a provisionally-registered state before completion of verification of the execution result, and information of a creator who created the cooperation processing flow; an acquisition unit that acquires access restriction information for the cooperation processing flow, which is set for each user, from an access management server connected via a network; and a control unit that controls an operation for the cooperation processing flow based on the registration type information of the cooperation processing flow corresponding to an operation request by the user, wherein when the cooperation processing flow is in the registered state, or when the cooperation processing flow is in the provisionally-registered state and the user is an administrator who has no access restrictions for the cooperation processing flow, the control unit controls the operation for the cooperation processing flow according to the access restriction information, and when the cooperation processing flow is in the provisionally-registered state, and the user is not the administrator, if the user is the creator of the cooperation processing flow, the control unit controls the operation for the cooperation processing flow according to the access restriction information, and if the user is not the creator of the cooperation processing flow, the control unit ends the operation for the cooperation processing flow.

Still another aspect of the present invention provides a control method of an image processing apparatus, which executes cooperation processing according to a cooperation processing flow which defines, in advance, a sequence of the cooperation processing for executing a plurality of functions in cooperation with each other, the method comprising: storing the cooperation processing flow together with registration type information indicating one of a registered state in which verification of an execution result is complete and a provisionally-registered state before completion of verification of the execution result; changing, when the cooperation processing flow corresponding to an execution request is in the provisionally-registered state, at least one function included in the cooperation processing flow to a function that allows a user to verify an execution result of the cooperation processing flow; and executing, when the cooperation processing flow corresponding to an execution request is in the registered state, processing according to the cooperation processing flow, and executing, when the cooperation processing flow is in the provisionally-registered state, the processing according to the cooperation processing flow changed in the changing.

According to the present invention, for example, an image processing apparatus that allows the user to verify the execution result of a created script, and a control method thereof can be provided.

Further features of the present invention will become apparent from the following description of exemplary embodiments (with reference to the attached drawings).

### BRIEF DESCRIPTION OF THE DRAWINGS

FIG. 1 is a diagram showing an example of the network configuration according to an embodiment of the present invention;

FIG. 2 is a block diagram showing an example of the hardware arrangement of an MFP according to the embodiment of the present invention;

FIG. 3 is a block diagram showing an example of the functional arrangement of the MFP according to the embodiment of the present invention;

FIG. 4 is a view showing an example of a user interface displayed on a liquid crystal display unit of an operation unit according to the embodiment of the present invention;

FIG. 5 is a flowchart showing the sequence of a script list display processing in the MFP according to the embodiment of the present invention;

FIG. 6 is a flowchart showing the processing sequence in a registration/edit mode in the MFP according to the embodiment of the present invention;

FIG. 7 is a flowchart showing the processing sequence in an execution mode in the MFP according to the embodiment of the present invention;

FIG. 8 is a view showing an example of an access restriction list according to the embodiment of the present invention; and

FIGS. 9A and 9B are views showing an example of the operation contents associated with a script in a provisionally-registered state according to the embodiment of the present invention.

### DESCRIPTION OF THE EMBODIMENTS

An embodiment of the present invention will be described hereinafter. The embodiment to be described hereinafter will help understanding of various concepts such as a broader concept, middle concept, and narrower concept of the present invention. Also, the technical scope of the present invention is defined by the scope of the claims, and is not limited by the following embodiment.

<Image Processing Apparatus and Network Configuration>

An embodiment of the present invention will be described below taking an MFP as an example of an image processing apparatus. A network configuration example will be explained first with reference to FIG. 1. All of an MFP 101, access management server 102, and client machine (PC) 103 are connectable to a LAN 110, and are ready to communicate with each other.

According to this embodiment, a cooperation processing flow (to be referred to as “script” hereinafter) is data which defines a sequence for executing at least one or more functions included in an apparatus such as the MFP 101 in combination (cooperation) with each other. Upon reception of a script execution instruction, the MFP 101 calls and executes functions defined in the script. The script includes at least three attributes, that is, creator information as a user identifier used to specify a creator who created the new script, owner information as a user identifier used to specify an owner of the script, and registration type information indicating a registration type of registration or provisional registration. When the user has not verified the execution result of the script yet, that script is set in a provisionally-registered state. When the user has verified the execution result of the script, that script can be set in a registered state. Functions included in apparatuses other than the MFP 101 may be defined in a script, and may be executed. Also, in a script, commands for parallelly executing a plurality of functions may be defined, or those for executing a plurality of functions in turn may be defined.

The access management server 102 is ready to communicate with the MFP 101 and client PC 103 via the LAN 110. The access management server 102 includes a large-capacity storage device, which stores access restriction information of scripts. The access restriction information indicates permission/prohibition of execution of operations (new registration, edit, delete, and copy) of scripts for each user. When an access restriction information request is received from the MFP 101, the access management server 102 extracts only required information from the storage device, and provides that information to the MFP 101 via the LAN 110. Note that the access restriction information need not always be stored in the access management server 102. For example, the access restriction information may be stored in a storage device (HDD) included in the MFP 101. Also, the access restriction information need not always be set for each user. For example, the access restriction information may be commonly set for all users or for respective user groups.

In the client PC 103, utility software that allows the user to create a script is installed. The MFP 101 can import the script created on the client PC 103 via the LAN 110. Note that the user can also create a script using an operation unit of the MFP 101.

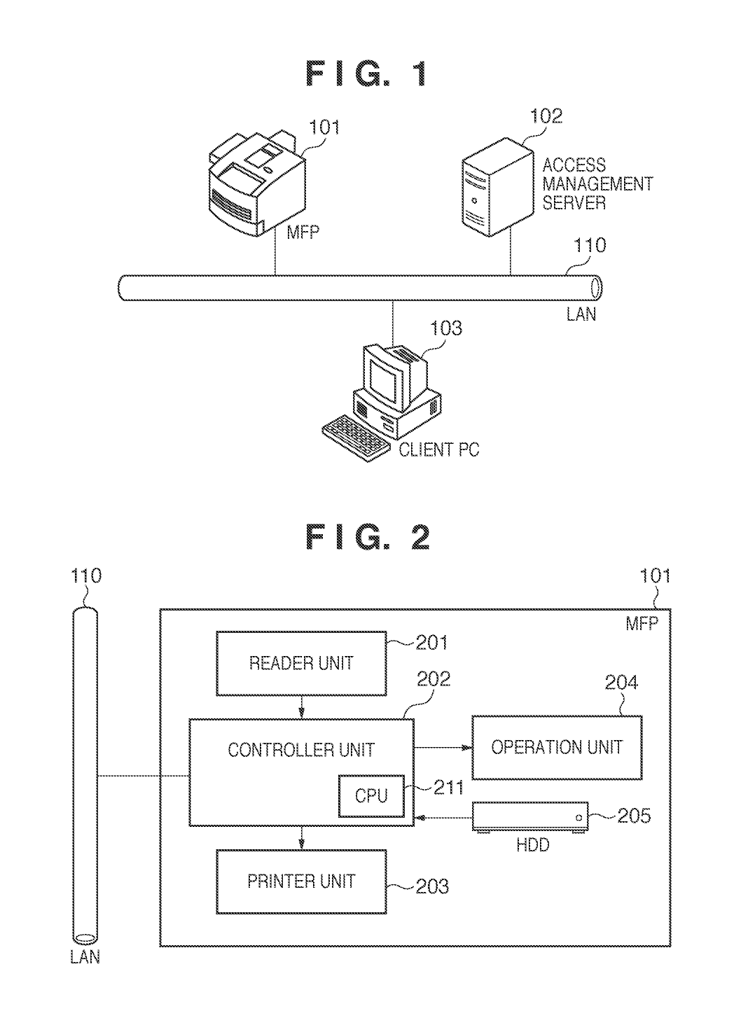

A hardware arrangement example of the MFP 101 will be described below with reference to FIG. 2. A reader unit 201, printer unit 203, operation unit 204, and HDD 205 of the MFP 101 are connected to each other via a controller unit 202, and also to the LAN 110 via the controller unit 202.

The reader unit 201 optically reads a document image, and converts it into image data. The reader unit 201 includes a scanner unit having a function of reading a document, and a document feeder unit having a function of conveying document sheets. Note that the reader unit 201 may not include any document feeder unit depending on the apparatus configuration. In this case, the reader unit 201 reads a document, which is placed on a platen glass, that is, a so-called pressing plate, using a sensor.

The printer unit 203 conveys a print sheet, prints image data on the print sheet as a visible image, and discharges the print sheet outside the apparatus. The printer unit 203 includes a paper feed unit which includes a plurality of types of paper cassettes, a fixing unit which transfers and fixes image data on a print sheet, and an paper discharge unit which sorts and staples printed print sheets and outputs the print sheets outside the apparatus.

The controller unit 202 includes a CPU 211 and a ROM and RAM (neither are shown), and controls the operations of the overall MFP 101. The controller unit 202 is electrically connected to the reader unit 201 and printer unit 203, and also to the LAN 110. The controller unit 202 provides a copy function that controls the reader unit 201 to read image data of a document, and controls the printer unit 203 to output the image data onto a print sheet. Also, the controller unit 202 provides a network scanner function that converts image data read from the reader unit 201 into code data, and sends the code data to the client PC 103 via the LAN 110. The controller unit 202 provides a box scan function that registers image data read from the reader unit 201 in a storage service called “box” included in the HDD 205. Furthermore, the controller unit 202 provides a printer function that converts code data received from the client PC 103 via the LAN 110 into image data, and outputs the image data to the printer unit 203.

The operation unit 204 includes a liquid crystal display unit, a touch panel input device adhered on the liquid crystal display unit, and a plurality of hardware keys, and provides a user interface (I/F) that allows the user to make various operations. A signal input by the touch panel input device or each hardware key is transferred to the controller unit 202. On the other hand, the operation unit 204 displays image data sent from the controller unit 202 on the liquid crystal display unit.

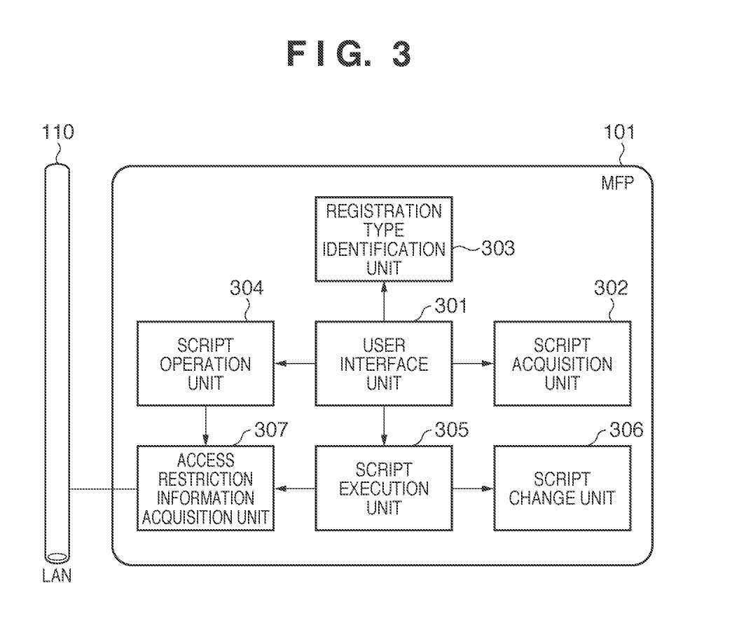

A functional arrangement example of the MFP 101 will be described below with reference to FIG. 3. Note that functional blocks to be described below are stored in the ROM of the controller unit 202 and implement predetermined functions in the MFP 101 when the CPU 211 executes the corresponding software.

A user interface unit 301 accepts an instruction input by the user via the operation unit 204. In this embodiment, the user interface unit 301 accepts a new registration instruction of a script in the HDD 205, a list display instruction of scripts stored in the MFP 101, script edit, delete, and copy instructions, and a script execution instruction. The CPU 211 executes a function according to the instruction input by the user interface unit 301. For example, upon reception of a script list display instruction, the CPU 211 identifies registration types of scripts using a registration type identification unit 303 (to be described later), and displays a list of scripts on the operation unit 204 based on the identification result.

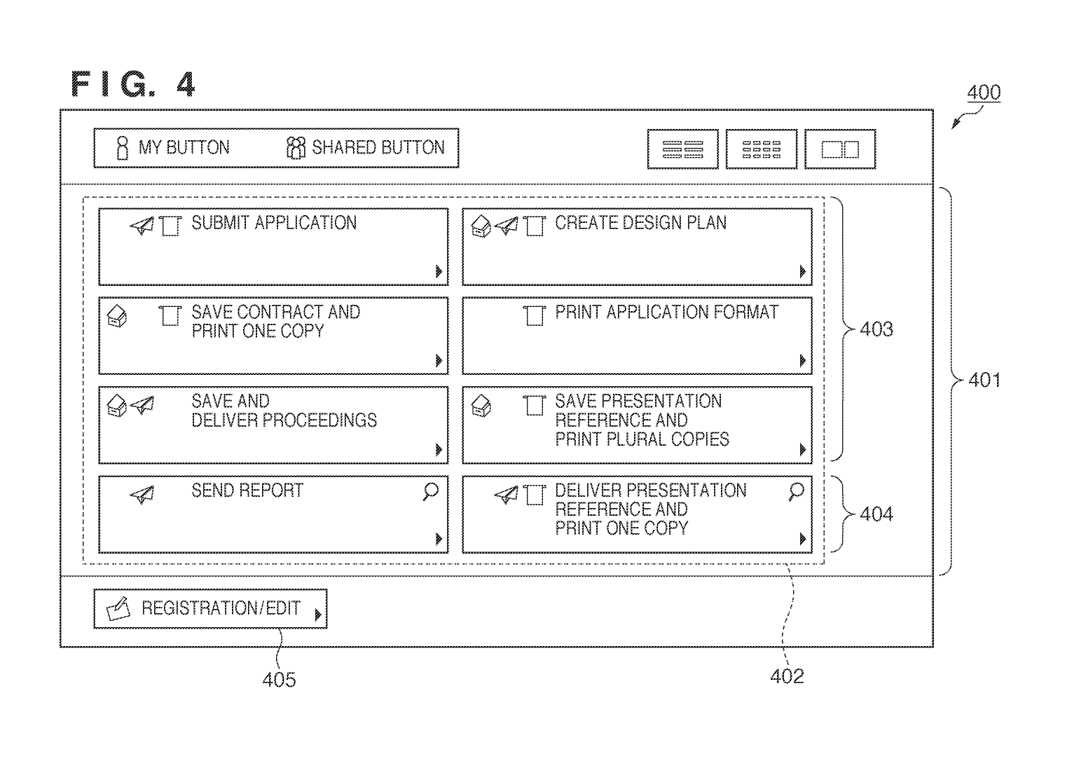

FIG. 4 shows an example of a user interface 400 displayed on the liquid crystal display unit of the operation unit 204. A list window 401 displayed on the user interface 400 includes a list of scripts stored in the MFP 101. The list window 401 displays script call buttons 402 in one-to-one correspondence with registered scripts, and these buttons 402 are laid out, as shown in FIG. 4. The user presses one of the script call buttons 402 in an execution mode to input a script execution instruction corresponding to that button to the MFP 101. When the user presses a button 405 to switch the execution mode to a registration/edit mode, and then presses the script call button 402, he or she can execute operations for that script. For example, the user can input a new registration instruction of a script corresponding to the button or an edit, delete, or copy instruction of the already registered script to the MFP 101.

Icons which allow the user to recognize registration types of scripts are displayed on the respective script call buttons 402 displayed on the list window 401. Buttons 403 in FIG. 4 indicate call buttons corresponding to scripts in the registered state, and buttons 404 indicate call buttons corresponding to scripts in the provisionally-registered state. The buttons 404 are displayed in a style appended with icons indicating that the corresponding scripts are in the provisionally-registered state. Thus, the user can easily discriminate whether scripts corresponding to the displayed buttons are in the registered or provisionally-registered state. Note that the method of indicating whether a script is in the registered or provisionally-registered state is not limited to the aforementioned icon display method. For example, the background colors of buttons may be changed in accordance with the registration types, or letters indicating the states may be displayed on the buttons. Furthermore, the sizes of buttons may be changed, or the buttons may be flickered.

In this embodiment, as will be described later, the buttons corresponding to respective scripts are displayed in turn on the list window 401. However, the present invention is not limited to this. For example, when the display positions of the scripts are predetermined, a button corresponding to a non-existing script may not be displayed at the predetermined position or may be displayed by hatching.

A script acquisition unit 302 acquires a script stored in the HDD 205. Note that scripts may be stored in another information apparatuses accessible via the LAN 110. In this case, the script acquisition unit 302 can acquire the script via the LAN 110.

The registration type identification unit 303 identifies a registration type as one of the pieces of attribute information included in each script. According to this embodiment, the registration type includes at least two types indicating the registered state and provisionally-registered state. Note that the registered state means a state in which verification associated with the propriety of the execution result of a script is complete, and that script is ready to operate. The provisionally-registered state means a state before verification associated with the propriety of the execution result of a script is complete, that is, a trial state before the beginning of an operation.

The registration type information can be set from the user interface unit 301 or a UI of the client PC 103 at the time of creation of a new script, and is recorded in the script. A script operation unit 304 stores the registration type information in the HDD 205 together with the corresponding script. Note that the registration type information may be stored in a memory included in the controller unit 202 of the MFP 101 in association with the corresponding script independently of that script.

The script operation unit 304 executes a predetermined operation for a script based on an instruction from the user interface unit 301. The user interface unit 301 supplies one of registration (new creation), delete, and copy instructions of a script to the script operation unit 304. Upon reception of these instructions, the script operation unit 304 executes the following operations. For example, when a new script is to be created, the script operation unit 304 creates (defines) a script according to a predetermined sequence based on various setting values input from the user interface unit 301, and stores the script in the HDD 205. When a script is to be deleted, the script operation unit 304 erases the designated script from the HDD 205. When a script is to be copied, the script operation unit 304 acquires a script designated from the user interface unit 301 using the script acquisition unit 302, copies the acquired script, and stores the copied script in the HDD 205. A script execution unit 305 acquires a script designated from the user interface unit 301 using the script acquisition unit 302, analyzes the script, and executes functions defined in that script. A script change unit 306 temporarily changes the contents of a script when the registration type identification unit 303 identifies that an attribute of that script indicates a provisionally-registered state.

An access restriction information acquisition unit 307 acquires an access restriction list of access restriction information associated with a login user on the MFP 101 from the access management server 102. Note that the access restriction information indicates permission/prohibition associated with new registration, edit, delete, and copy operations of a script. These pieces of information are registered for respective users in association with user identifiers. A user type is defined in the user identifier, and the access restriction information acquisition unit 307 can identify based on the defined user type whether the user is an administrator or normal user. Note that the administrator is a user who has no access restrictions for scripts, and a normal user is a user other than the administrator.

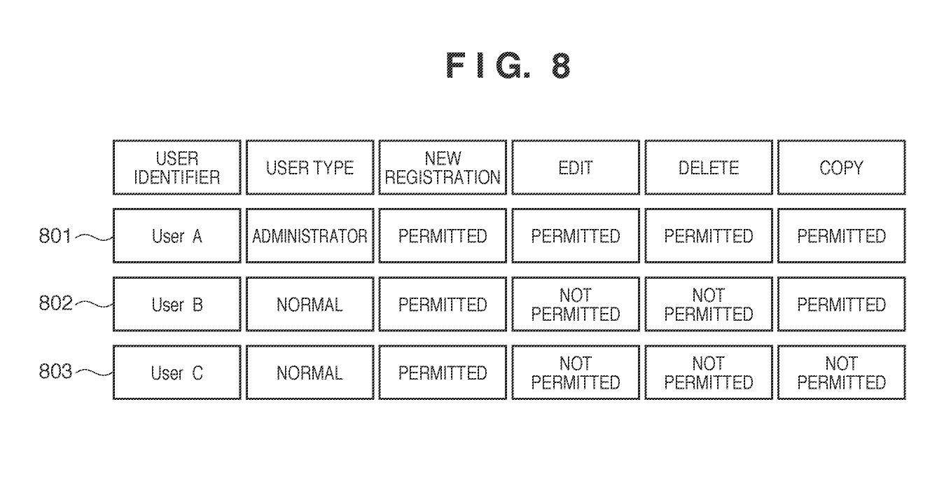

FIG. 8 shows an example of the access restriction list, and shows pieces of access restriction information for three users. For user A (801) whose user type is “administrator”, all of new registration, edit, delete, and copy operations of scripts are permitted. For user B (802) and user C (803) whose user type is “normal user”, only some operations are permitted.

<List Display Processing Sequence>

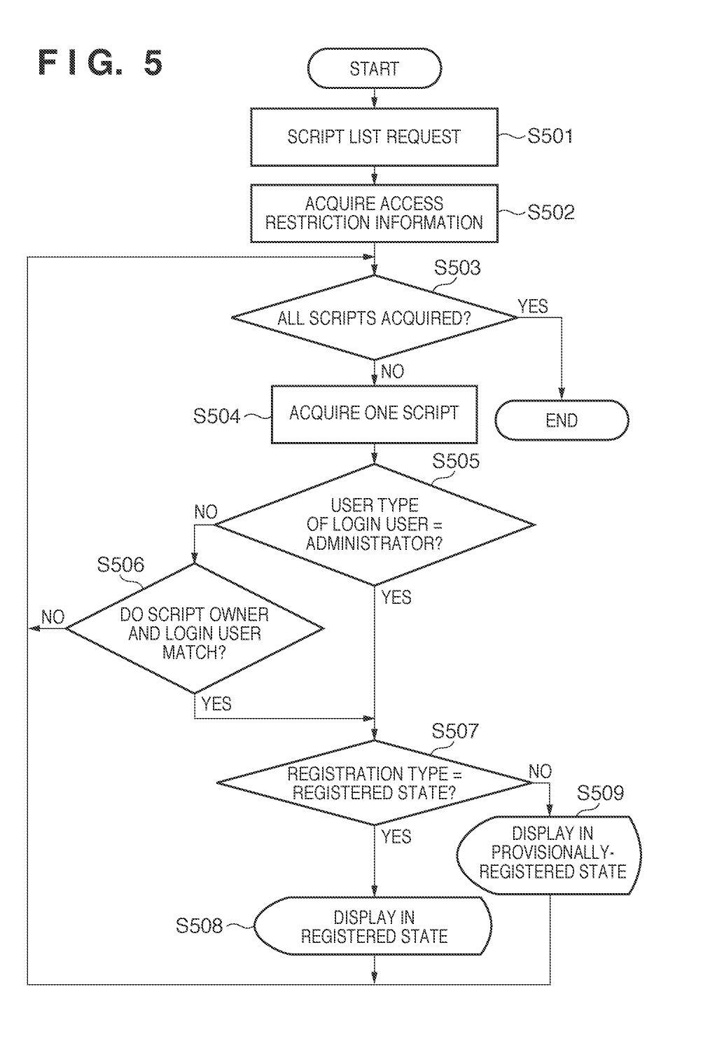

The list display processing sequence of scripts in the MFP 101 will be described below with reference to FIG. 5. Note that respective steps of this flowchart are executed by the CPU 211 of the controller unit 202.

In step S501, the CPU 211 controls the user interface unit 301 to display the list window 401 on the liquid crystal display unit of the operation unit 204 based on a script list request by a user (login user) who has logged in the MFP 101. Furthermore, in step S502 the CPU 211 controls the access restriction information acquisition unit 307 to acquire the user type of each user and a restriction list for scripts. After that, the process advances to step S503.

The CPU 211 checks in step S503 whether or not all scripts to be displayed as a list are acquired. If acquisition of all the scripts is complete, the processing ends. On the other hand, if acquisition of all the scripts is not complete yet, the process advances to step S504, and the CPU 211 controls the script acquisition unit 302 to acquire one script, which is not acquired yet, of all the scripts to be displayed as a list. After that, the process advances to step S505.

The CPU 211 checks in step S505 whether or not the user type of the login user is “administrator”. If the user type of the login user is “administrator”, the process advances to step S507. On the other hand, if the user type of the login user is not “administrator” but it is “normal user”, the process advances to step S506. In step S506, the CPU 211 refers to a user identifier included in owner information of the attributes of the acquired script to check whether or not that user identifier matches that of the login user. If the two user identifiers do not match, the process returns to step S503 without selecting that script as a display target on the list window 401. On the other hand, if the two user identifiers match, the process advances to step S507.

In step S507, the CPU 211 refers to registration type information of the attributes of the acquired script to check whether or not the script is in the registered state. If the script is in the registered state, the process advances to step S508, and the CPU 211 displays a button corresponding to the registered state on the list window 401. On the other hand, if the script is in a provisionally-registered state, the process advances to step S509, and the CPU 211 displays a button corresponding to the provisionally-registered state on the list window 401, as described above. After that, the process returns to step S503 to repeat the aforementioned processes until processes associated with all the scripts are completed.

<Registration/Edit Mode Processing Sequence>

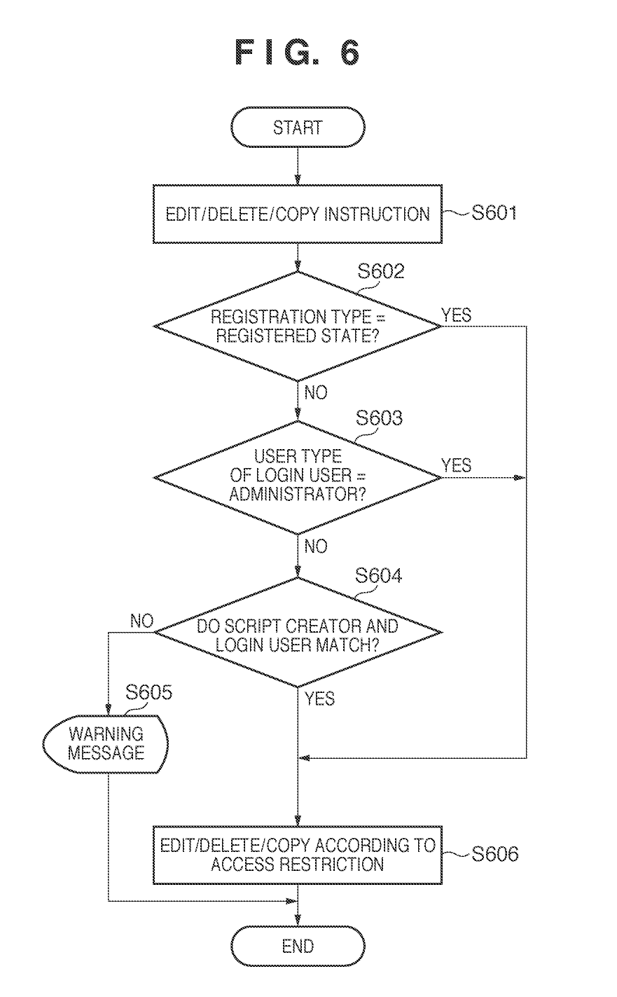

The CPU 211 displays the list window 401 on the liquid crystal display unit of the operation unit 204 according to the sequence shown in FIG. 5. When the user presses the button 405 to switch the execution mode to the registration/edit mode, and then presses one of the script call buttons 402 displayed on the list window 401, the processing based on the sequence shown in FIG. 6 is executed. Note that respective steps of the flowchart shown in FIG. 6 are executed by the CPU 211 as in FIG. 5.

In step S601, the CPU 211 supplies one of the edit, delete, and copy instructions for the script designated by the user interface unit 301 to the script operation unit 304. Furthermore, in step S602 the CPU 211 controls the registration type identification unit 303 to check with reference to the registration type information included in the attributes of the script whether or not the registration type indicates a registered state. If the registration type indicates a registered state, the process advances to step S606. On the other hand, if the registration type indicates not a registered state but a provisionally-registered state, the process advances to step S603.

The CPU 211 checks in step S603 based on the access restriction list acquired by the access restriction information acquisition unit 307 whether or not the user type of the login user is “administrator”. If the user type of the login user is “administrator”, the process advances to step S606. On the other hand, if the user type of the login user is not “administrator” but it is “normal user”, the process advances to step S604.

The CPU 211 checks in step S604 with reference to the user identifier included in the creator information of the attributes of the designated script whether or not that user identifier matches that of the login user. If the two user identifiers match, the process advances to step S606. On the other hand, if the two user identifiers do not match, the process advances to step S605 to display a predetermined message on the liquid crystal display unit of the operation unit 204. As the predetermined message, a message “the operation is denied since the current state is the provisionally-registered state” is displayed. Furthermore, the CPU 211 rejects the request designated by the user interface unit in step S601, and ends the processing without executing any processing for the script.

When the process reaches step S606 from the aforementioned steps, the CPU 211 controls the script operation unit 304 to execute the processing according to the access restriction information included in the access restriction list. In this case, the CPU 211 rejects a request which is not permitted in the access restriction information, and executes only processing associated with a permitted request.

In this embodiment, when a normal user who is not a creator of a script requests to execute, for example, an edit operation of that script in the provisionally-registered state, that request is always rejected. However, the present invention is not limited to this. For example, access restriction information for scripts in the registered state and that for scripts in the provisionally-registered state may be defined for each user identifier, and the access restriction information to be referred to may be switched according to the attributes of a script.

In an environment in which the access management server 102 or MFP 101 does not manage any access restriction information, if it is determined in step S602 that the script is in the provisionally-registered state, a confirmation message that advises accordingly (for example, “Do you want to proceed with the operation although the current state is the provisionally-registered state?”) may be displayed on the liquid crystal display unit of the operation unit 204 before permitting the request.

<Execution Mode Processing Sequence>

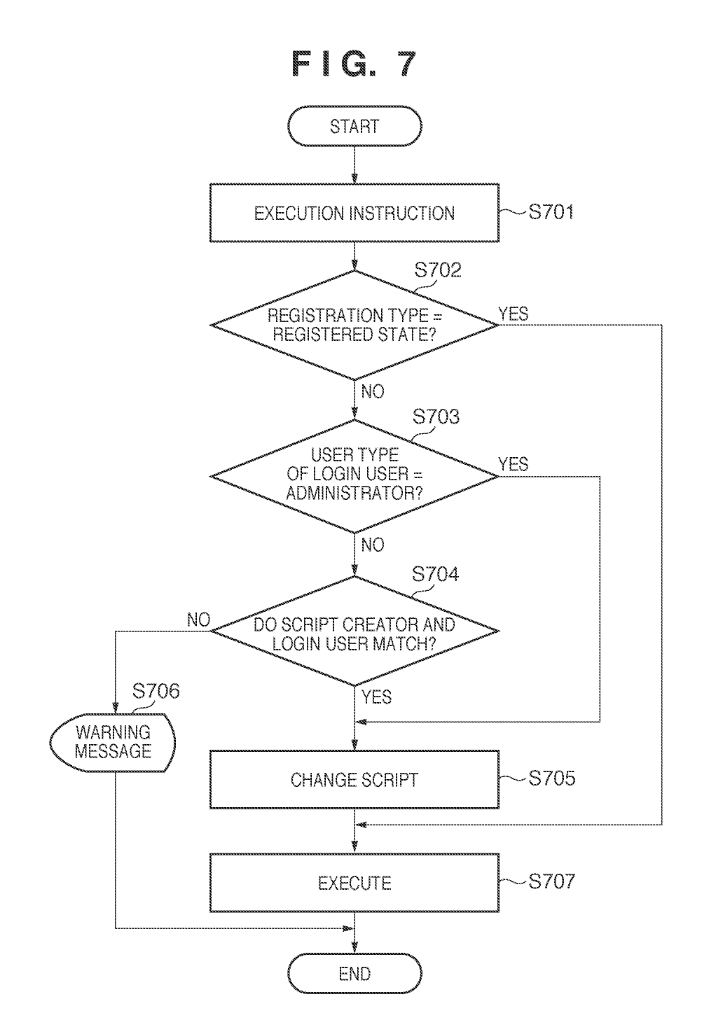

When the list window 401 is displayed on the liquid crystal display unit of the operation unit 204 according to the sequence shown in FIG. 5, and the user presses one of the script call buttons 402 in the execution mode, the processing based on the sequence shown in FIG. 7 is executed. Note that respective steps of the flowchart shown in FIG. 7 are executed by the CPU 211 as in FIGS. 5 and 6.

In step S701, the CPU 211 supplies an execution instruction for the script designated by the user interface unit 301 to the script execution unit 305. Furthermore, in step S702 the CPU 211 controls the registration type identification unit 303 to check with reference to the registration type information in the attributes of the script whether or not the registration type indicates a registered state. If the registration type indicates a registration state, the process advances to step S707. On the other hand, if the registration type indicates not a registered state but a provisionally-registered state, the process advances to step S703.

The CPU 211 checks in step S703 based on the access restriction list already acquired by the access restriction information acquisition unit 307 whether or not the user type of the login user is “administrator”. If the user type of the login user is “administrator”, the process advances to step S705. On the other hand, if the user type of the login user is not “administrator” but it is “normal user”, the process advances to step S704.

The CPU 211 checks in step S704 with reference to the user identifier included in the creator information in the attributes of the designated script whether or not that user identifier matches that of the login user. If the two user identifiers match, the process advances to step S705. On the other hand, if the two user identifiers do not match, the process advances to step S706, and a predetermined message is displayed on the liquid crystal display unit of the operation unit 204. As the predetermined message, for example, a message “the script cannot be executed since the current state is the provisionally-registered state” is displayed. Furthermore, the CPU 211 rejects the execution request of the script designated by the user interface unit 301 in step S701, and ends the processing without executing the script.

As a result of the checking process in step S703 or S704, if the user type of the login user is “administrator” or if the login user is a script creator although he or she is not “administrator”, the CPU 211 executes the process in step S705. In step S705, the CPU 211 temporarily changes some functions included in the definition of the script. More specifically, the CPU 211 changes a function used to output the execution result in the script to that which allows the user to verify the execution result.

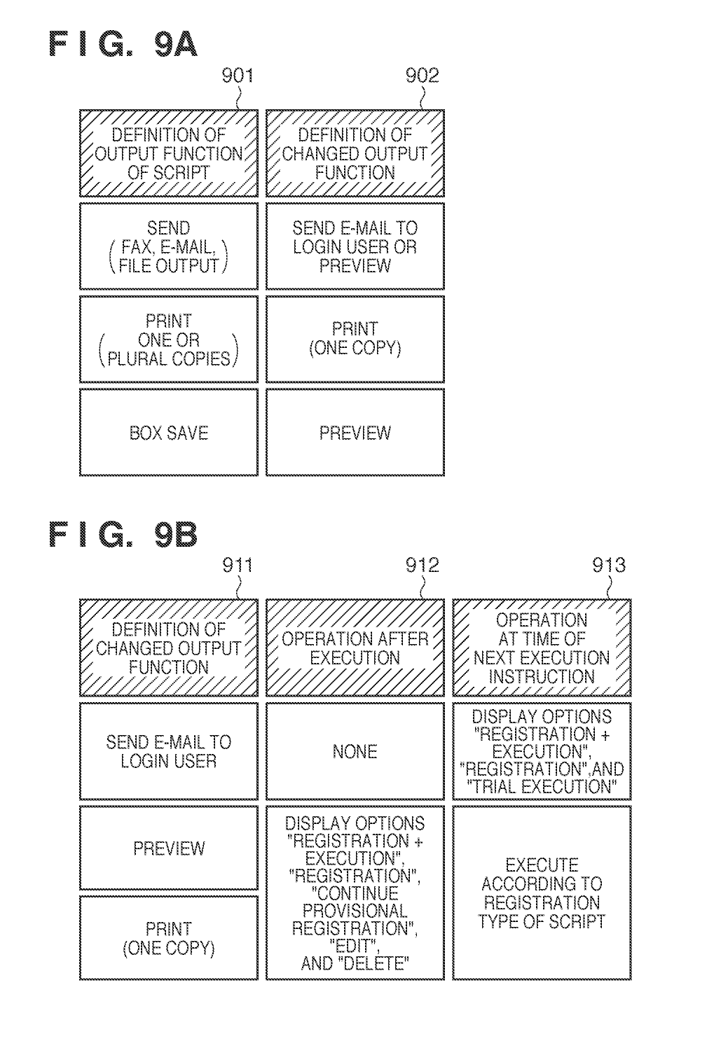

An example of change rules in a script will be described below with reference to FIG. 9A. For example, when a function defined to output the execution result (901) in a script actually created by the user is a send function (FAX, E-mail, and file output (SMB, FTP, etc.)), that send method is changed to “E-mail send”, and the send destination is changed to the E-mail address of the login user (902). Note that the E-mail address of the login user is recorded in a login context at the time of the login process to the MFP 101. When the login context does not record any E-mail address, the send method is changed to “image preview”, and an image is displayed on the liquid crystal display unit of the operation unit 204. In this way, the user can verify the execution result of the script by confirming the layout and colors of the output result in advance before he or she sets the script in the registered state. Note that some functions of the script may be changed to registered functions when the user registers the change rules from the user interface unit 301 in advance.

On the other hand, when the function defined to output the execution result (901) is a print function, the number of copies is changed to print only one copy (902). Then, the user can confirm whether or not printed matter has a desired finishing style and the like by confirming the printed matter only in a small quantity before the beginning of the actual operation of the script in the registered state.

Furthermore, when the function defined to output the execution result (901) is a box save function, this function is changed to an image preview function (902). Thus, the user can confirm the layout and colors of a saved image without issuing a preview instruction again.

If the script change process in step S705 is complete or if the registration type of the script indicates a registered state as a result of the checking process in step S702, the CPU 211 executes the script in step S707. If the registration type of the script indicates a registered state, the CPU 211 executes respective functions of the MFP 101 according to the definition contents of the script. On the other hand, if the registration type of the script indicates a provisionally-registered state, the CPU 211 executes respective functions of the MFP 101 according to the definition contents of the script after the change process in step S705.

In an environment in which the access management server 102 or MFP 101 does not manage any access restriction information, if it is determined in step S702 that the script is in the provisionally-registered state, a confirmation message that advises accordingly (for example, “Do you want to proceed with execution of the script although the current state is the provisionally-registered state?”) may be displayed on the liquid crystal display unit of the operation unit 204, and the script may be executed without changing its contents.

In this embodiment, when the script in the provisionally-registered state is executed in the sequence shown in FIG. 7, the user may perform some operation on the script based on the execution result. FIG. 9B shows an example of the operation contents of the MFP 101 after execution of the script in the provisionally-registered state. When the MFP 101 executes contents 911 as a function of the script after the change process, it determines an operation 912 after execution based on its definition.

For example, when the function of the script after the change process (911) is a preview or print (one copy) function, the MFP 101 displays options such as “edit” and “delete” that allow to operate the script itself in addition to options such as “registration+execution”, “registration”, and “continue provisional registration” that allow to operate the registration type of the script, on the liquid crystal display unit of the operation unit 204 (912). That is, the MFP 101 allows the user to confirm the execution result (product) of the script in the provisionally-registered state, and to, for example, modify the script on site. For example, when the user selects “registration+execution” or “registration”, the registration type of the script is changed to indicate a registered state; when the user selects “continue provisional registration” or “edit”, the registration type of the script is maintained to indicate a provisionally-registered state. After that, when the user interface unit 301 issues an execution request of that script again, the processing shown in FIG. 7 is executed according to the registration type of the script (913).

On the other hand, when the function of the script after the change process (911) is an E-mail send function to the login user, the user generally confirms the execution result on the client PC 103 in place of the MFP 101. Thus, the MFP 101 promptly ends execution without executing any special operation after execution of the script (912).

In this case, the MFP 101 may store the changed contents of the script which has been executed once. When an execution instruction of the same script is issued, the MFP 101 displays options “registration+execution”, “registration”, and “trial execution” on the liquid crystal display unit of the operation unit 204 based on the stored contents (913). The script execution unit 305 changes the registration type according to the contents of user's choice. For example, when the user selects “registration+execution” or “registration”, the script execution unit 305 changes the registration type of that script to indicate a registered state; when the user selects “trial execution”, the unit 305 maintains a provisionally-registered state. Also, the script execution unit 305 executes the script in the sequence shown in FIG. 7 according to the registration type of that script.

As described above, when the image processing apparatus according to this embodiment executes processing according to a script (cooperation processing flow) that defines, in advance, the sequence of cooperation processing for executing a plurality of functions in cooperation with each other, it temporarily changes some functions included in the script based on the registration type information of that script. More specifically, when that script is in the registered state in which verification associated with the propriety of the execution result is complete, the apparatus executes the processing according to the script. On the other hand, when the script is in the provisionally-registered state before completion of verification associated with the propriety of the execution result, the apparatus automatically changes some functions included in the script to a function that allows the user to verify the execution result, and executes the processing according to the changed definition. As described above, according to this embodiment, the user can promptly confirm the execution result of the script. Especially, the administrator who has no access restrictions to the script or the creator of the script can easily verify the propriety of the execution result of the script, thereby improving user's convenience.

When the script is in the provisionally-registered state, the image processing apparatus according to this embodiment limits an operation for the script to the administrator who has no access restrictions to the script or the creator of the script. Then, access management for a script before transition to the registered state can be facilitated, and operations of that script can be appropriately controlled.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-174731, filed Jul. 27, 2009, which is hereby incorporated by reference herein in its entirety.

What is claimed is:

1. An image processing apparatus, which executes cooperation processing according to a cooperation processing flow which defines, in advance, a sequence of the cooperation processing for executing a plurality of functions in cooperation with each other, the apparatus comprising:
a storage unit that stores the cooperation processing flow together with registration type information indicating one of a registered state in which verification of an execution result is complete and a provisionally-registered state before completion of verification of the execution result;
a change unit that changes, when the cooperation processing flow corresponding to an execution request is in the provisionally-registered state, at least one function included in the cooperation processing flow to a function that allows a user to verify an execution result of the cooperation processing flow; and
an execution unit that executes, when the cooperation processing flow corresponding to an execution request is in the registered state, processing according to the cooperation processing flow, and executes, when the cooperation processing flow is in the provisionally-registered state, the processing according to the cooperation processing flow changed by the change unit.

2. The apparatus according to claim 1, further comprising a determination unit that determines an operation after execution of the cooperation processing flow by the execution unit based on a definition of the cooperation processing flow changed by the change unit.

3. The apparatus according to claim 1, further comprising an acquisition unit that acquires access restriction information for the cooperation processing flow, which is set for each user, from an access management server connected via a network,
wherein the storage unit further stores information of a creator who created the cooperation processing flow,
when the user is an administrator who has no access restrictions for the cooperation processing flow or the creator, the change unit changes at least one function included in the cooperation processing flow to a function that allows the user to verify the execution result of the cooperation processing flow, and
when the user is neither the administrator nor the creator, the change unit ends execution of the cooperation processing flow.

4. The apparatus according to claim 1, wherein the storage unit further stores access restriction information for the cooperation processing flow, which is set for each user, and information of a creator who created the cooperation processing flow,
when the user is an administrator who has no access restrictions for the cooperation processing flow or the creator, the change unit changes at least one function included in the cooperation processing flow to a function that allows the user to verify the execution result of the cooperation processing flow, and
when the user is neither the administrator nor the creator, the change unit ends execution of the cooperation processing flow.

5. The apparatus according to claim 1, further comprising a display unit that displays a list of cooperation processing flows stored in the storage unit by displaying buttons corresponding to the cooperation processing flows in accordance with the registration type information.

6. The apparatus according to claim 5, wherein the storage unit further stores information of an owner of the cooperation processing flow, and
the display unit displays a list of only the cooperation processing flows of the owner.

7. An image processing apparatus, which executes cooperation processing according to a cooperation processing flow which defines, in advance, a sequence of the cooperation processing for executing a plurality of functions in cooperation with each other, the apparatus comprising:
a storage unit that stores the cooperation processing flow together with registration type information indicating one of a registered state in which verification of an execution result is complete and a provisionally-registered state before completion of verification of the execution result, and information of a creator who created the cooperation processing flow;
an acquisition unit that acquires access restriction information for the cooperation processing flow, which is set for each user, from an access management server connected via a network; and
a control unit that controls an operation for the cooperation processing flow based on the registration type information of the cooperation processing flow corresponding to an operation request by the user,
wherein when the cooperation processing flow is in the registered state, or when the cooperation processing flow is in the provisionally-registered state and the user is an administrator who has no access restrictions for the cooperation processing flow, the control unit controls the operation for the cooperation processing flow according to the access restriction information, and
when the cooperation processing flow is in the provisionally-registered state, and the user is not the administrator, if the user is the creator of the cooperation processing flow, the control unit controls the operation for the cooperation processing flow according to the access restriction information, and if the user is not the creator of the cooperation processing flow, the control unit ends the operation for the cooperation processing flow.

8. A control method of an image processing apparatus, which executes cooperation processing according to a cooperation processing flow which defines, in advance, a sequence of the cooperation processing for executing a plurality of functions in cooperation with each other, the method comprising:
storing the cooperation processing flow together with registration type information indicating one of a registered state in which verification of an execution result is complete and a provisionally-registered state before completion of verification of the execution result;
changing, when the cooperation processing flow corresponding to an execution request is in the provisionally-registered state, at least one function included in the cooperation processing flow to a function that allows a user to verify an execution result of the cooperation processing flow; and
executing, when the cooperation processing flow corresponding to an execution request is in the registered state, processing according to the cooperation processing flow, and executing, when the cooperation processing flow is in the provisionally-registered state, the processing according to the cooperation processing flow changed in the changing.
